(19) United States
(12) Patent Application Publication
(10) Pub. No.: US 2022/0260316 A1
(43) Pub. Date: Aug. 18, 2022

(54) CROSS-FLOW HEAT EXCHANGERS AND METHODS OF MAKING THE SAME

(71) Applicant: MEGGITT AEROSPACE LIMITED, COVENTRY (GB)

(72) Inventors: Jenna Nicole Becker, Burbank, CA (US); Steven William James Henderson, Rugby (GB); Catherine Joanna Todd, Birmingham (GB); Christopher Simon Elliott, Redditch (GB)

(21) Appl. No.: 17/531,681

(22) Filed: Nov. 19, 2021

Related U.S. Application Data
(60) Provisional application No. 63/126,460, filed on Dec. 16, 2020.

(51) Int. Cl. F28D 1/02

(52) U.S. Cl. CPC F28D 1/0233; F28F 2250/106

(57) ABSTRACT

A heat exchanger comprising a plurality of A channels in a heat exchanger matrix running in a first direction wherein each A channel is formed along its length as a waveform with an identical wavelength, channel width, wave angle, and wall thickness. Adjacent A channels running in an orthogonal direction are 180 degrees out of phase. The plurality of A channels form the plurality of B channels running in a cross-flow direction with the outer walls of the A channels. The B channels exist as the negative space between adjacent 180 degree out of phase A channels.

### CROSS REFERENCE TO RELATED APPLICATION

The present application claims the benefit of U.S. Provisional Application No. 63/126,460, filed Dec. 16, 2020, which is hereby incorporated by reference in its entirety and is considered a part of this specification.

### FIELD

This patent document relates to cross-flow heat exchangers and methods of making the same. In particular, this patent document relates to new geometric designs for cross-flow heat exchangers that result in heat exchangers with improved efficiencies.

### BACKGROUND

The requirements posed by aircraft engines are changing over time, and engines have evolved dramatically in the last fifty years. As may be seen in FIG. 1, present day engines like the Rolls-Royce Trent 1000 engine 10 dwarf the size of an older fuselage like that of the Concorde 11 and its Rolls-Royce/Snecma Olympus 593 engines 12.

Traditionally, nacelles housed a multitude of components including the accessory gearbox, air-oil heat exchangers and the Full Authority Digital Engine Control (FADEC). As engine fan diameters increase, the size of the nacelle would theoretically need to increase as well. However, the drag generated by the larger nacelle eventually becomes too large. Accordingly, thinner and thinner nacelle designs have become commonplace a.k.a. slim-line nacelles. Larger engines and fans and thinner nacelles reduces the volume left to house the components traditionally housed within the nacelle. As an alternative, these components have been housed within the core zone. As the core zone already houses ducting, pipework, bleed assemblies and other components, relocated hardware previously housed within the nacelle can prove to be a challenge due to envelope constraints.

The increase in fan diameter creates changes to other assembly level requirements including a requirement to reduce the fan speed relative to the turbine speed. A reduction of the fan rotational speed with respect to the turbine rotational speed may be accomplished with an additional gearbox. Currently, heat load from the accessory gearbox, bearings and generators is typically used to pre-heat the fuel with the excess heat being fed into the bypass duct air flow, or into air flow external to the nacelle. It is estimated that the additional gearbox to reduce the fan speed will grossly increase the heat load introduced into the oil. Because the current designs already produce more heat than can be absorbed by the fuel during preheating, the additional heat load from the extra gear box must be dissipated into the bypass duct air flow.

As engine manufacturers strive towards more fuel-efficient architectures, assemblies which are usually driven by compressor discharge pressure, such as Environmental Control Systems (ECS), are being powered by electric assemblies. These assemblies put extra demand on the electrical generators; again, this additional energy results in extra heat load being dissipated into the oil.

As the space around the core of the engine begins to fill with equipment, emphasis is put on reducing the space taken up by individual pieces of equipment. This begins a significant challenge for the heat exchangers where they are required to manage approximately double the heat load but in a smaller volume.

Applicant currently designs and manufactures plate and fin construction heat exchangers for air oil and low-pressure fuel oil applications. An illustration of a plate and fin heat exchanger can be seen in FIG. 2.

Plate and fin heat exchangers are constructed from layers of corrugated fins sandwiched between parting plates. The fins are supported by bars which are located at either end of the fin layer. The heat exchangers transfer heat from the hot fluid of the heat exchanger (depending on the application of the heat exchanger) to the metal surrounding the fluids. The fins act as secondary heat transfer surface area and transfer the heat to the other fluid via conduction. Side plates cap the top and bottom of the plate/fin stack.

The fins and the parting plates are typically 3000 series aluminum. The corrugated surfaces (fins) are produced on a fin forming machine in a variety of patterns e.g. plain, lanced, wavy, perforated or louvered. In most cases the height of the fin and fin density can be tailored to the operating conditions and mechanical constraints of the particular application. Parting plates, or separator sheets as they are also known, are usually from thin gauge material and are clad with a braze alloy on both sides to allow bonding to the fin surfaces. Side plates may be cut from sheet. This would be clad on one side only or, if thicker plates are required for strength, a brazing shim may be added to allow bonding. The bars that close each layer of the matrix are made from a specific extruded section or may be machined from solid if a particular feature in the matrix is a requirement.

The heat exchanger matrix is then assembled in purpose designed fixtures and brazing jigs. The upper platform of the jig is under spring pressure pushing the surfaces together as the matrix contracts when the clad surfaces disperse to form the joints and fuse together during the brazing process.

The resulting heat exchanger is restricted to rectangular shapes by their construction. The construction also constrains the heat exchanger to being formed in discrete layers. This results in the necessity to use fins to add additional surface area. The fins are classed as secondary heat transfer surface area which has an inherent inefficiency associated with the convective and conductive heat transfer. The layered construction also limits the variation in the flow configurations that can be employed; where typically for plate and fin heat exchangers cross-flow configurations are used. Parallel flow or counter flow configurations can be used but require complex and expensive header constructions.

In recent years, advancements in additive manufacturing have made it a viable option for the production of heat exchangers and heat exchanger components. The use of additive manufacturing for heat exchangers has opened up new possibilities for heat exchanger geometries. In particular, heat exchangers can now be made with geometries that do not have to conform to standard manufacturing principles.

Accordingly, there is a need for new heat exchanger designs that improve on previous designs in any of the heat exchangers criteria but in particular in the areas of efficiency, size and weight.

### SUMMARY OF THE EMBODIMENTS

Objects of the present patent document are to provide an improved heat exchanger and improved methods for making heat exchangers. To this end, various embodiments of heat exchangers and methods of making heat exchangers are provided.

The overall form of the heat exchanger is not constrained to cuboid shapes as is typical of current plate and fin heat exchangers. The form of the improved heat exchanger can be curved or conical and/or include conformal regions to enable design flexibility when integrating the heat exchanger design into the application environment.

In preferred embodiments, the heat exchangers described herein comprise a plurality of A channels in a heat exchanger matrix running in a first direction. Each A channel has an exterior with an exterior shape and an interior with an interior shape. In preferred embodiments the exterior and interior shapes are the same such that the A channels have a consistent wall thickness. In addition, each A channel in the plurality of A channels is formed along its length as a waveform. Preferably, all the A channels are made with a very similar shape and have an identical wavelength, channel width, wave angle, and wall thickness.

In preferred embodiments, the A channels are repeated in two orthogonal directions. A first portion of A channels are offset in a second direction that is orthogonal to the first direction wherein adjacent A channels in the first portion of A channels are 180 degrees out of phase and the peaks and troughs of the adjacent A channels form nodes.

The heat exchanger further has a plurality of B channels that are formed from the negative space between the exteriors of the adjacent 180 degree out of phase A channels. Accordingly, a cross-section of each B channel in the plurality of B channels is formed between two nodes by the negative space inside the exterior walls of the adjacent A channels.

The lattice of the A channels running in the first direction is repeated axially to form the length of the B channels. Accordingly, a second portion of A channels in the plurality of A channels are arranged in a third direction orthogonal to the first direction and orthogonal to the second direction wherein each A channel in the first portion of A channels has a plurality of A channels in the second portion of A channels offset by an offset distance in the third direction to form continuous interior walls of the plurality of B channels in the third direction from the exterior walls of the plurality of A channels.

As may be appreciated, the exterior shape and interior shape of the A channels may be any shape. In preferred embodiments, the exterior shape and interior shape are circles and the channel width is a diameter.

In preferred embodiments, the cross-section of each B channel is four sided. In ever more preferred embodiments, the cross-sectional perimeter of each B channel is a diamond.

Depending on the embodiment, the nodes or junctions where out of phase A channels come together may be linked or unlinked. If the nodes are linked, fluid or gas from different A channels may mix at the nodes. In embodiments where the nodes are unlinked, fluid from adjacent A channels may not mix at the nodes.

In some embodiments, the adjacent A channels are offset in the second direction by an amplitude of the waveform. In other embodiments, other offsets may be used.

In embodiments wherein the A channels have linked nodes, a diameter at a junction of the nodes may be twice an interior diameter of an A channel. In other embodiments, the diameter of the junction may vary from zero at an unmixed node to anything up to twice an interior diameter of an A channel. In other embodiments, the diameter of the junction may be ever larger than twice the interior diameter of an A channel.

In order to reduce drag, in some embodiments, the interior corners of each fluid B channel in the plurality of fluid B channels is rounded.

In order to allow the heat exchanger to fit in a curved space or along a curved path, in some embodiments, the flow path of each B channel in the plurality of B channels is not a straight line. In yet other embodiments, the second portion of A channels are lanced and offset.

In preferred embodiments, the axial offset distance is between one channel width and one channel width minus two times the wall thickness. This prevents A channels from mixing in the axial direction. In other embodiments, the offset distance is less than one channel width minus two times the wall thickness such that adjacent A channels are connected along their lengths.

In yet another embodiment of the heat exchangers disclosed herein, the heat exchanger comprises: a plurality of A channels in a heat exchanger matrix all running in a first direction. The A channels all have an exterior with an exterior shape and an interior with an interior shape. Each A channel in the plurality of A channels is formed along its length as a waveform with an identical wavelength, channel width, wave angle, and wall thickness. A first portion of A channels in the plurality of A channels are mirrored in a second direction that is orthogonal to the first direction about a mirror plane to form adjacent A channels in the plurality of A channels. The mirror plane is defined by either a plurality of peaks or a plurality of troughs of the first portion of A channels. Peaks and troughs of adjacent A channels form nodes. The matrix further includes a plurality of B channels formed wherein a cross-section of each B channel in the plurality of B channels is defined between two nodes by the negative space inside the exterior walls of the first portion of A channels and adjacent A channels. A second portion of A channels in the plurality of A channels are arranged in a third direction orthogonal to the first direction and orthogonal to the second direction. Each A channel in the first portion of A channels has a plurality of A channels in the second portion of A channels offset by an offset distance in the third direction to form continuous interior walls of the plurality of B channels in the third direction from the exterior walls of the plurality of A channels.

In another configuration of embodiments of cross-flow heat exchangers, the heat exchanger comprises a first plurality of A channels formed in a shape of a first section of a first pattern of involutes. A second plurality of A channels formed in a shape of a second section of a second pattern of involutes where the second pattern of involutes is symmetric and counter-rotating to the first pattern of involutes are overlayed and intersecting the first pattern of involutes in a plane to form a lattice of interconnected A channels.

A plurality of B channels are formed by repeating the lattice of interconnected A channels in a direction normal to the plane such that adjacent lattices of interconnected A channels are touching wherein each B channel in the plurality of B channels is defined by the exterior walls of the adjacent lattices of interconnected A channels.

In designing heat exchangers using involutes, the ratio between the base circle and the exterior or interior of the core section can be varied. The ratio of the diameter of a base circle of the first pattern of involutes and a second diameter of an inner core section should be such to make sure the geometry is buildable.

In preferred embodiments, a second ratio of a diameter of a second base circle of the second pattern of involutes is identical to the first ratio of the first pattern of involutes such that the first pattern of involutes and second pattern of involutes are identical in counter rotating directions.

The first angular spacing between arms of the first pattern of involutes should also be design to make sure the geometry is buildable. In some embodiments, a second angular spacing between arms of the second pattern of involutes is the same as the first angular spacing.

Preferably, the hydraulic diameter of each B channel in the plurality of B channels is identical.

In embodiments using involutes, the first plurality of A channels and the second plurality of A channels are connected via linked nodes at their intersections. In some embodiments, a portion of the plurality of B channels are lanced and offset in a repeating pattern.

In many embodiments, in order to make larger overall heat exchangers, the heat exchanger matrix is broken into more than one build. This allows the use of additive manufacturing, which is limited by an overall size, to build bigger heat exchangers. Preferably, the heat exchanger matrix is defined by an arc on a top side and a concentric arc of larger diameter on a bottom side and the two arcs are connected by straight lines to form a segment. Multiple segments may be combined to form a larger heat exchanger.

In preferred embodiments, each segment is comprised of a plurality of sections wherein each section is defined by a pair of different diameter arcs connected by the straight lines.

### BRIEF DESCRIPTION OF THE DRAWINGS

FIG. 1 illustrates a comparison of the relative size of present-day engines with the fuselage of the Concorde.

FIG. 2 illustrates an exterior isometric view of a plate and fin heat exchanger according to the prior art.

FIG. 3 illustrates a cut-away schematic view of the plate and fin heat exchanger of FIG. 2.

FIG. 4 illustrates an exterior isometric view of a heat exchanger matrix according to the teachings herein.

FIG. 5 illustrates a plan view looking straight down the fluid B channels of the heat exchanger matrix 10 of FIG. 4.

FIG. 6 illustrates a cross-section view of two adjacent fluid A channels with a different fillet radius between the fluid A channels on the top and bottom varying the scallop form.

FIG. 7 illustrates a cross-section view of two adjacent fluid A channels where the fillet between the fluid A channels has an infinite radius thus removing the scallop form.

FIG. 8 illustrates the fluid B volume of three fluid B channels with variations in their “scallop”.

FIG. 9 illustrates the four major parameters than can be adjusted to tune heat exchanger performance: wave angle, wavelength, fluid A channel diameter, and wall thickness.

FIG. 10 illustrates a cross-section of a heat exchanger matrix where the adjacent fluid A channels share a wall at the turns in the flow path (hereafter called “nodes”) but the fluid paths do not intersect—forming a lattice with “unlinked nodes”.

FIG. 11 illustrates a cross-section of a heat exchanger matrix of an alternative embodiment to FIG. 10 where the adjacent fluid A channels have nodes where the fluid paths do intersect—forming a lattice with “linked nodes”.

FIG. 12 illustrates a subsection of a matrix with fluid A channel unlinked nodes 32 that have rounded corners on the fluid B channels.

FIG. 13 illustrates a subsection of a matrix with fluid A channel linked nodes 34 that have rounded corners on the fluid B channels.

FIG. 14 illustrates a linked node with a junction that has a cross-section A2 that is double the diameter A1 of the fluid A channel.

FIG. 15 illustrates an isometric view of one embodiment of a matrix with a fluid B flow path that is wavy.

FIG. 16 illustrates an isometric view of one embodiment of a matrix with a fluid B flow path that is lanced and offset.

FIG. 17 illustrates a trapezoidal fluid A path.

FIG. 18 illustrates a sinusoidal fluid A path.

FIG. 19 illustrates an isometric view showing the spacing between the fluid A channels in an embodiment where fluid cannot flow between the channels.

FIG. 20 illustrates an isometric view showing the spacing between the fluid A channels in an embodiment where fluid can flow between the channels.

FIG. 21 illustrates a cross-sectional view of a series of fluid A channels with no profile on the inlet.

FIG. 22 illustrates a cross-sectional view of a series of fluid A channels with an inlet profiled for normal flow.

FIG. 23 illustrates a cross-sectional view of a series of fluid A channels with an inlet profiled for inclined flow.

FIG. 24 illustrates a cross-sectional view of a heat exchanger matrix with internal turns

FIG. 25 illustrates a cross-sectional view of a heat exchanger matrix with an external turn.

FIG. 26 illustrates a cross-sectional view of a traditional header, with the fluid A flow entering into a single cavity and into the matrix through a tube-plate style interface.

FIG. 27 illustrates a cross-section view of a different embodiment made possible by the design freedom of additive manufacture in which fluid could be routed from the inlet port into each individual fluid A channel row.

FIG. 28 illustrates a schematic of a plurality of involutes.

FIG. 29 is an axial view down the fluid B channels showing the A channel lattice of a matrix with an involute construction.

FIG. 30 illustrates a view looking down the B channels of a lanced and offset heat exchanger matrix using involutes.

FIG. 31 illustrates an isometric view of the lanced and offset heat exchanger matrix of FIG. 30.

FIG. 32 illustrates a heat exchanger core with three separate involute heat exchanger matrices in which the three zones have different lattice spacing angles and base circle diameters.

FIG. 33 illustrates a heat exchanger matrix using involutes with three segments wherein each segment has three sections.

FIG. 34 illustrates cross-sectional view of an angled cross-flow heat exchanger with turning vanes to guide airflow into the inclined heat exchanger.

FIG. 35 illustrates a sectional view along section A-A of FIG. 34 showing a lattice matrix which is rotated to provide a series of continuous horizontal surface for turning vane alignment.

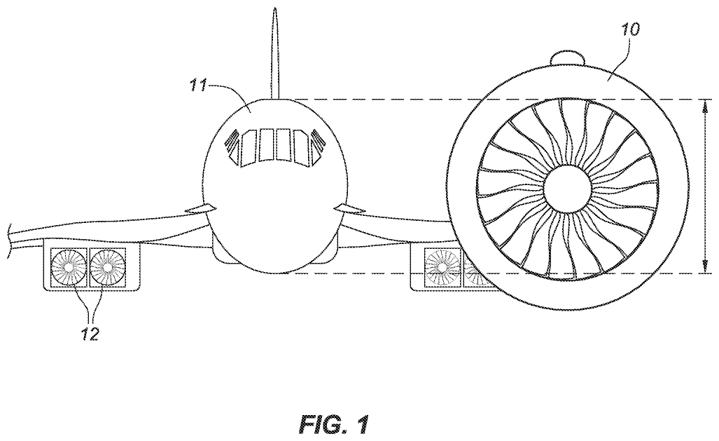

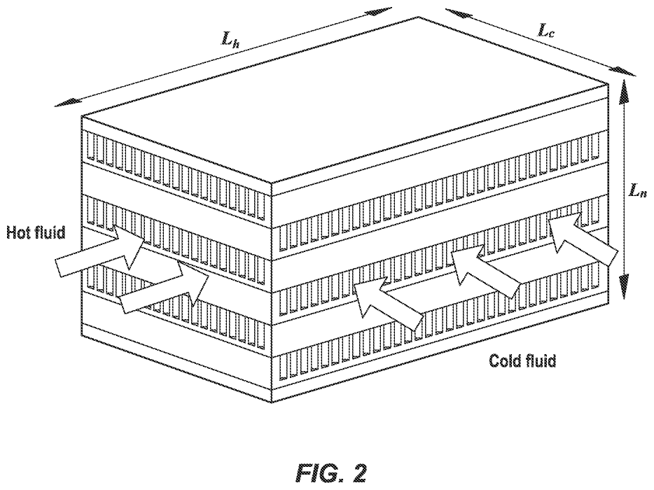

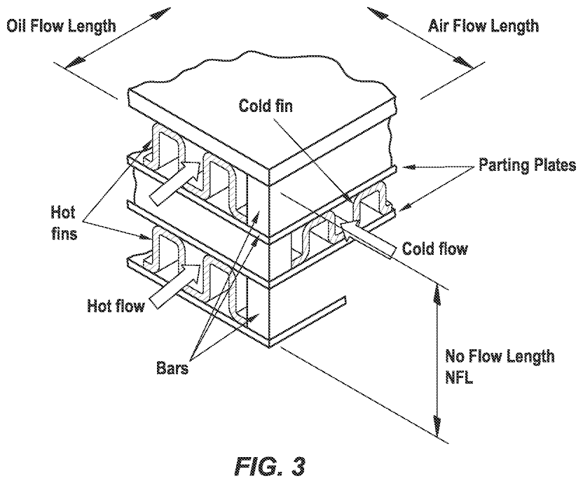

### DETAILED DESCRIPTION OF THE DRAWINGS

The present patent document describes embodiments of heat exchangers that eliminate or at least ameliorate some of the problems with previous heat exchanger designs. In particular, the heat exchanger described herein may increase the flow area and heat transfer surface area per unit volume.

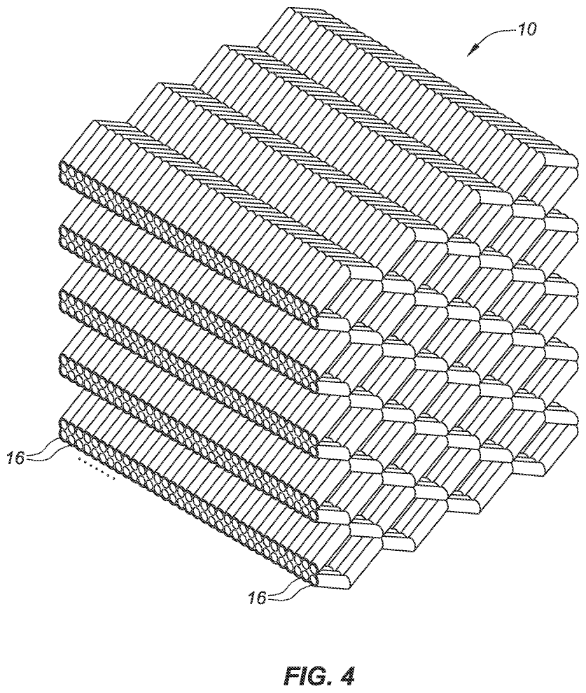

FIG. 4 illustrates an exterior isometric view of a heat exchanger matrix 10 according to the teachings herein. The cross-flow heat exchanger 10 may be manufactured using non-conventional additive manufacturing techniques. This means a single-piece build is possible, reducing the need for secondary machining or joining processes. As may be seen in FIG. 4, rows 16 of fluid A channels 14 are in the shape of a waveform along their lengths and the waveforms of the fluid A channels 14 are aligned to form the fluid B channels.

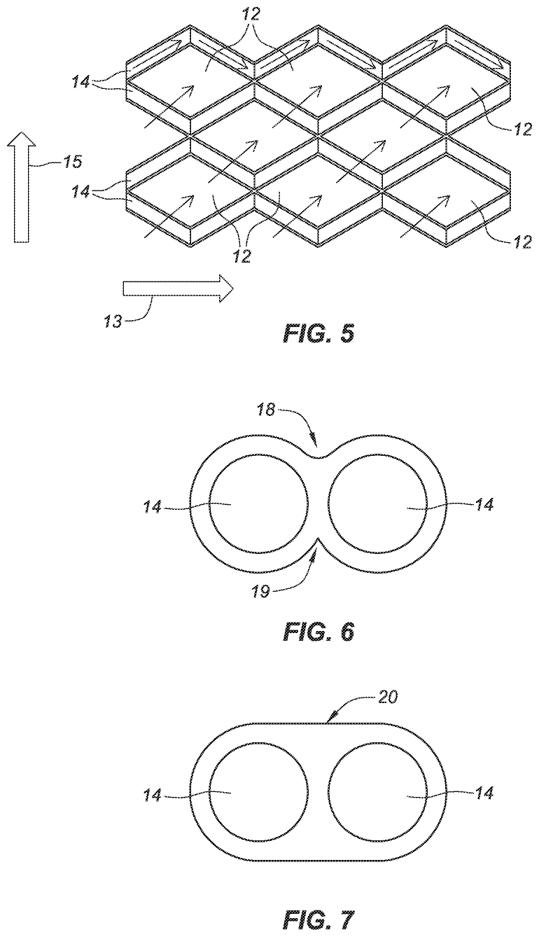

FIG. 5 illustrates a plan view looking parallel to the fluid B channels 12 of the heat exchanger matrix 10 of FIG. 4. In the view shown in FIG. 5, the cross-section of the fluid B channels may be seen with the length of the fluid B channels going in and out of the page. In this heat exchanger embodiment, the flow paths of the fluid A (typically liquid) channels 14 are from left to right in a first direction 13. When referring to the flow path of the A channels 14, it is the overall direction 13 that is being referred to. As may be seen, the A channels 14 oscillate up and down along their lengths as part of their waveform design but generally are moving in a single first direction 13, from left to right in FIG. 5.

As may be seen, in the embodiment in FIG. 5, the A channels 14 are arranged in a plane. The plan is the plan defined by the page of FIG. 5 or the plane can be thought of as defined by the first direction 13 and the second direction 15 which is orthogonal to the first direction 13. The adjacent A channels in the second direction 15 are 180 degrees out of phase and are spaced such that the exterior walls of the negative space between the out of phase adjacent A channels form the cross-sectional perimeters of the fluid B (gas) channels 12. This resulting lattice is then repeated in the direction normal to the plane with each overlapping the next by up to one wall thickness to form rows 16 of fluid A channels 14. The negative space between these fluid A channels 14 creates the flow path of the fluid B channels 12.

The cross-flow heat exchangers described herein creates a compact fluid A channel 14 and fluid B channel 12 packaging arrangement. In preferred embodiments, the fluid B channel 12 flow path is formed completely from the negative space between fluid A channels 14 resulting in 100% primary heat transfer surface area, improving heat transfer performance per unit volume.

Another advantage is that the heat exchangers described herein are not limited to cuboid configurations, and can be curved or conform to unusual space envelopes.

Another potential advantage is that the linked tubular arrangement is structurally robust. Moreover, the lattice structure can be “lanced and offset” in which each lattice, or group of lattices, may be variously translated such as to disturb the fluid B channel path 12, increasing heat transfer.

In some embodiments, the fluid A channel tube fronts can be profiled for pressure loss reduction; these can act as turning vanes in inclined heat exchanger applications. In addition, variable fluid B channel dimensions that match the inlet flow profile can be used to further improve the efficiency of the system. While these are some of the potential advantages to the cross-flow heat exchangers described and taught herein, other advantages will become clear from the full disclosure that follows.

The applications for the heat exchangers described herein are not limited to any particular application; however, the cross-flow heat exchangers described herein may be used for: Air-Oil; Main oil circuit, oil cooling; Power gearbox (fan reduction) oil circuit; Integrated drive generator (IDG) oil circuit, oil cooling; Variable frequency generator (VFG) oil circuit, oil cooling; Permanent magnet generator (PMG) oil circuit, oil cooling; Air-Air; Turbine blade/guide vane cooling; Buffer seal air cooling.

As discussed, the heat exchanger designs taught herein results in a compact packaging of the heat exchanger channels. Because the fluid B channels 12 are formed solely by the negative space between fluid A channels 14, the resulting matrix 10 has an increased flow area and heat transfer surface area per unit volume. The channel packaging also means that the heat transfer surface area of the fluid B channels 12 is one-hundred percent primary surface area, resulting in increased heat exchanger performance as there is no compound restriction on secondary surface area efficiency.

FIG. 6, illustrates a cross-section view of two adjacent fluid A channels 14 with a different fillet radius on the top and bottom creating different scallop forms 18 and 19. As may be appreciated from FIG. 6, the exterior shape and interior shape of the A channels 14 are round. In other embodiments, other shapes can be used such as square, diamond, triangle, hexagon, pentagon, octagon or any other shape. In addition, different shapes may be used for the exterior shape and the interior shape depending on the design requirements.

Because the fluid B heat transfer surface area is formed from the outer diameter of the fluid A channels 14, when the exterior shape of the A channels is round, the fluid B channel flow path will have a scalloped shape 18 and 19. The resulting scallops formed by the adjacent fluid A channels 14 are normal to the fluid B channels flow direction, increasing heat transfer surface area. The radius of the fillet at the joint between fluid A channels 14 can be varied to balance heat transfer surface area and pressure loss as the application requires. The radius of the fillet at the joint between fluid A channels 14 can be varied to balance heat transfer surface area and pressure loss as the application requires. As illustrated in FIG. 6, scallop 18 has a 0.2 mm fillet radius while the bottom scallop has a full scallop or 0 mm fillet radius. In other embodiments other radii can be used. In some embodiments, the radius may be a percentage of the tube outer radius, for example 10%. Additionally, secondary surface area or surface roughness can be added to the fluid channels to further enhance the heat transfer performance.

FIG. 7 illustrates a cross-section view of two adjacent fluid A channels where the fillet between the fluid A channels has an infinite radius 20. As shown in FIG. 7, the infinitely large fillet forms a fluid B channel with no scallops.

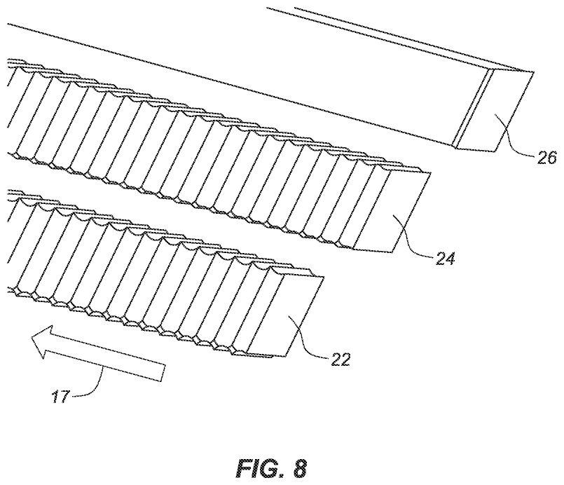

FIG. 8. illustrates the fluid B volume of three fluid B channels with variations in their “scallop”. FIG. 8 illustrates full scallops with no fillet 22 (lower left), scallops with fillet 24 (centre), and no scallops 26 (upper right).

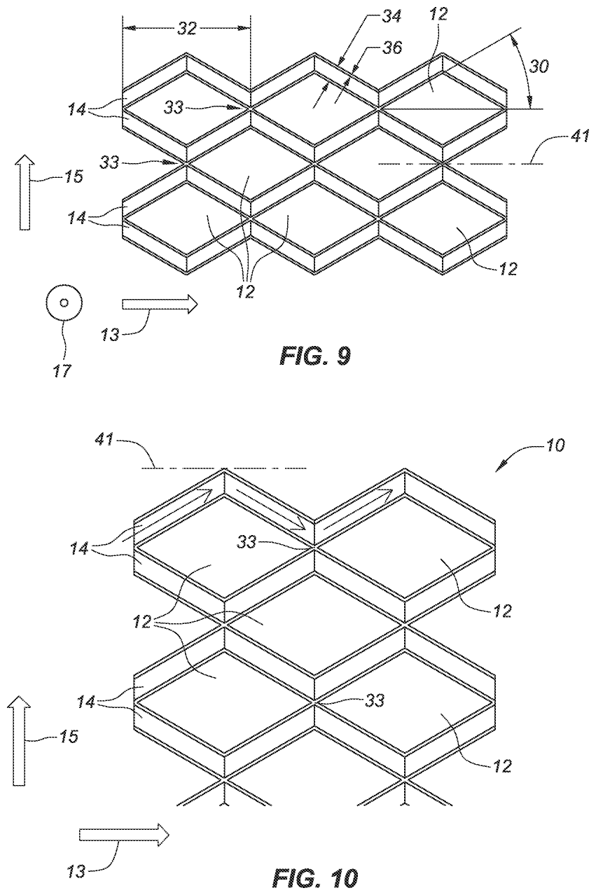

FIG. 9 illustrates a cross-sectional view of the heat exchanger matrix of one embodiment that illustrates the major parameters than can be adjusted to tune heat exchanger performance: wave angle 30, wavelength 32, fluid A channel width 34, and wall thickness 36.

As may be seen in FIG. 9, the heat exchanger matrix has a plurality of A channels running in a first direction 13. As may be appreciated, the A channels are generally all in a plane defined by the page of FIG. 9 or the two axis defined by the first direction 13 and the second direction 15. Each A channel in the plurality of A channels has an exterior with an exterior shape and an interior with an interior shape.

As the A channels 14 run in the first direction 13, from left to right in FIG. 9, the A channels 14 have a waveform along their lengths. By adjusting the A channel wave angle 30 and wavelength 32, the form of the fluid A channel 14 path will be affected. Changing the A channel wave angle 30 and wavelength 32 will also affect the fluid B channel 12 size and aspect ratio.

As may be seen in FIG. 9, the wavelength is defined by the distance from trough to trough or from peak to peak with a single trough or peak in between. Typically, wavelength is defined peak to peak or trough to trough and that may also be done here as long as consistent.

The wave angle is the angle between a centreline or baseline and the inclination of the rising wave. Generally, the wave angle 30 can vary between 10 and 80 degrees. However, wave angles between 30 and 60 degrees are more preferred because they avoid sharp internal fluid B channel 12 corners where fluid B may stagnate. The wave angle 30 affects both the aspect ratio of the fluid B channel 12 and the path of the fluid A channel 14. A wave angle of 30 degrees and 60 degrees would result in the same shape of fluid B channel 12 (only its orientation is affected), but would result in two distinct fluid A channel flow paths 14. In the example shown in FIG. 9, a 30-degree wave angle 30 would be preferred where low fluid A pressure is required and a lower heat transfer can be accepted; a 60-degree wave angle 30 would be preferred where more heat transfer is required and a higher fluid A pressure loss can be accepted.

The channel width 34 of the A channels is the distance across the exterior of a single fluid A channel. If the A channel is not symmetric, it is the distance across the A Channel in the direction along the length of the B channel. In preferred embodiments, the exterior cross-section of each A channel 14 is a circle such that the channel width 34 becomes a diameter.

The A channel wall thickness 36 is defined by the distance from the inner wall of an A channel 14 to the outer wall of an A channel 14. In preferred embodiments, each A channel has the identical wall thickness 36 and the wall thickness is consistent throughout the length of each A channel 14. The A channel width 34 and wall thickness 36 can be tailored to suit the heat exchanger's operating pressures and contamination requirements while minimizing the weight and volume of the final heat exchanger.

In preferred embodiments, the inner diameter of the fluid A channels 14 could range from 1 mm up to 3 mm. A smaller inner diameter for the fluid A channels 14 is preferred when more heat transfer is required and higher fluid A pressure loss can be accepted. A larger inner diameter for the fluid A channels 14 is preferred when lower fluid A pressures are required and a lower heat transfer can be accepted.

In preferred embodiments, the wall thickness 36 of the A channels 14 can range from 0.200 mm to 0.500 mm. A smaller wall thicknesses 36 offers lower weight and higher surface area per volume, to the detriment of structural capability.

FIG. 5 also illustrates the wave amplitude 31. Although the wave amplitude is a product of the wavelength 32 and wave angle 30, it is shown here for clarity. The amplitude 31 is the distance from peak to trough of a single A channel 14.

In preferred embodiments, each A channel 14 has the identical wavelength 32, channel width 34, wave angle 30 and wall thickness 36. In some embodiments, slight variations can occur but in general, the heat exchanger's herein result from the arrangement and patterning of identical A channels.

As may be seen in FIG. 5, a plurality of A channels is repeated in the second direction 15, which is orthogonal to the first direction 13. When repeated in the second direction, adjacent A channels 14 have their waveform 180 degrees out of phase. This creates a pattern in the second direction where every other A channel is in phase.

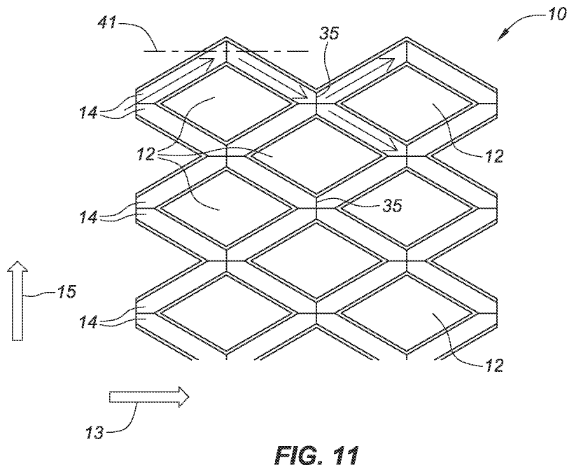

As can be seen in FIG. 5, each A channel is offset in the second direction 15 one wave amplitude 31 such that peaks and troughs of the adjacent A channels form nodes 33. In other embodiments, the offset in the second direction 15 may be slightly more or slightly less that one wave amplitude 31. If the offset is slightly less than a wave amplitude 31, and in particular less by at least the wall thickness, then adjacent A channels may combine. This will be discussed in more detail with respect to FIGS. 11 and 13.

As may be appreciated, alternating A channels 14 in the second direction have all their troughs as part of a node 33 and the remaining alternating A channels 14 in the second direction have all their peaks as part of a node 33.

As may be appreciated from FIG. 5, a plurality of B channels 12 are formed in between the peaks and troughs of the A channels wherein the cross-section of each B channel is formed between two nodes 33 by the negative space inside the exterior walls of the adjacent A channels 14. In preferred embodiments, each B channel is completely closed off from every other B channel. However, if the A channel offset in the second direction 15 is more than one wave amplitude 31, individual B channels 12 may be connected with other B channels 12 in the first direction 13.

FIG. 9 illustrates a cross-section of the heat exchanger matrix. In order to create the full heat exchanger matrix, the A channels shown in FIG. 9 are replicated in a third direction 17 (in and out of the page in FIG. 9) orthogonal to the first direction 13 and orthogonal to the second direction 15. Accordingly, each A channel shown in FIG. 9, i.e. each A channel in the cross-section of the matrix, has a plurality of A channels offset by an offset distance in the third direction 17 to form continuous interior walls of the plurality of B channels 12 in the third direction from the exterior walls of the plurality of A channels.

Returning to FIG. 8, the interior walls of the B channels may be seen with the third direction 17 illustrated. In a preferred embodiment, the offset distance in the third direction is one channel width 34 such that the walls of the B channels are continuous and each A channel is separate from other A channels in the third direction 17. However, in some embodiments, the offset distance in the third direction 17 may be less than the channel width. In such embodiments, if the offset distance is less than a channel width 34 by at least two wall thicknesses. A channels in the third direction will have interiors that allow mixing. FIG. 20 will illustrate this in more detail.

FIG. 10 illustrates a cross-section of a heat exchanger matrix 10 where the adjacent fluid A channels 14 share a wall at the turns in the flow path (hereafter called “nodes”) 33 but the fluid paths do not intersect—forming a lattice with “unlinked nodes” 33. As explained with respect to FIG. 9, this occurs when the A channels are offset in the second direction by the amplitude 31 of one wave and phase shifted with respect to each other. As may be appreciated, this does not have to be exactly the amplitude 31 of one wave but must be within the tolerance of a wall thickness 36. Rather than offset and phase shifted, the A channels could be mirrored in the second direction about a mirror plane 41, which is parallel to the first direction and passes through the A channel wall thickness 36 at the nodes. The results will be the same. As may be appreciated, the mirror plane 41 does not have to pass through the exact center of the wall thickness 36 but must be within the tolerance of a wall thickness 36.

FIG. 11 illustrates a cross-section of a heat exchanger matrix of an alternative embodiment to FIG. 10 where the adjacent fluid A channels 14 have nodes 35 where the fluid paths do intersect—forming a lattice with “linked nodes” 35. As may be seen in FIG. 11, a matrix 10 can be formed from fluid A channels 14 that intersect completely at each node (i.e. “linked nodes”) 35, meaning that fluid in the A channels 14 can mix between flow paths at each node 35 (see FIG. 11). The embodiment in FIG. 11 is created by offsetting the fluid A channels in the second direction 15 by less than the amplitude 31 of one wave. In order to make the interior side walls of the A channels 14 line up exactly, the offset needs to be less than the amplitude 31 of a wave by half of the channel width 34 multiplied by the tangent of the wave angle 36. As with the embodiments in FIGS. 9 and 10, the embodiment in FIG. 11 can also be created by mirroring. The fluid A channels may be mirrored in the second direction 15 about a mirror plane 41, which is parallel to the first direction and bisects the A channel where its flow path turns. In order to make the interior side walls of the A channels 14 line up exactly, each mirror plane 41 will be offset by half the wavelength 32 multiplied by the tangent of the wave angle 36.

A matrix 10 with linked nodes 35 is more compact, giving the potential to pack more heat transfer surface area into a given volume. Additionally, it mitigates the risk of losing a channel due to a contaminant blockage as the flow can take alternative channel paths through the heat exchanger 10. On the other hand, a matrix with unlinked nodes 33 (See FIG. 10) means that fluid A flows in an unmixed cross flow configuration, which is the optimal cross flow configuration to maximise heat transfer performance.

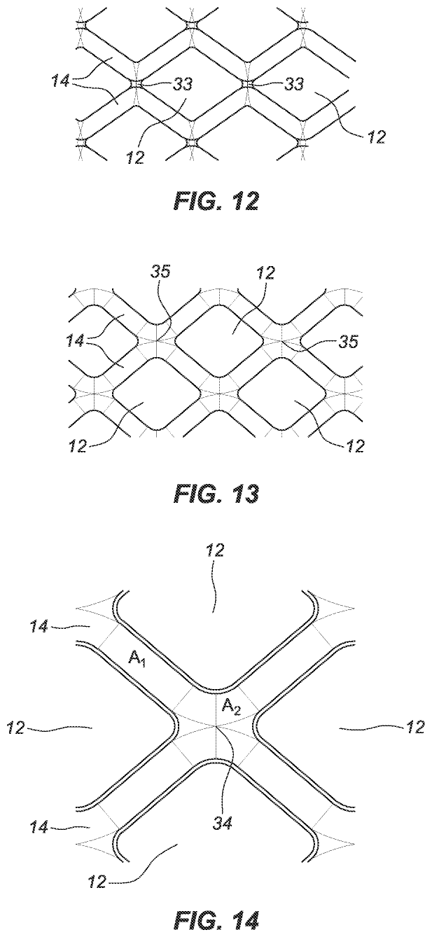

The fluid A channel junctions or nodes 33, 35 may be shaped to create rounded corners on the interior edges or corners of the fluid B channels 12. This may help to avoid stagnated flow in the narrow corners of the fluid B channels 12, reducing pressure loss. This could also reduce stress concentrations, leading to a stronger matrix. FIG. 12 illustrates a subsection of a matrix with fluid A channel unlinked nodes 33 that have rounded corners on the fluid B channels. FIG. 13 illustrates a subsection of a matrix with fluid A channel linked nodes 35 that have rounded corners on the fluid B channels 12.

In some embodiments with linked nodes 35, junctions can be shaped in such a way that the free flow area of the fluid A channels 14 remains consistent as the channels join and separate at the nodes. FIG. 14 illustrates a linked node 35 with a junction that has a cross-section A2 that is twice the diameter A1 of the A channel 14. A larger cross-section at the connected linked nodes 35 ensures a steady, uniform flow through the fluid A channels 14.

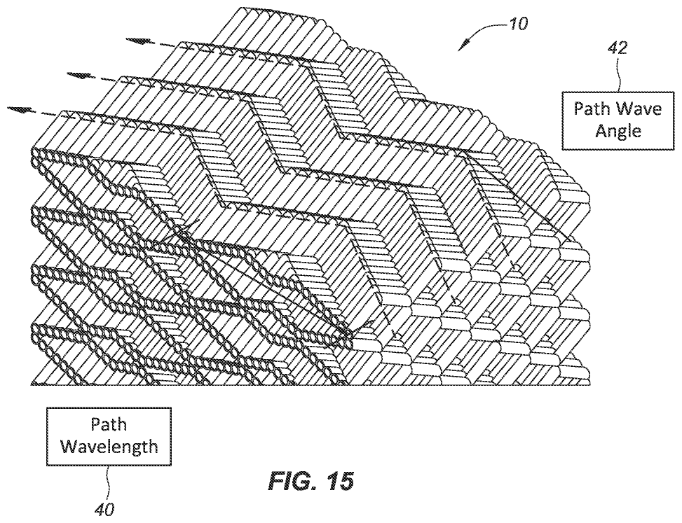

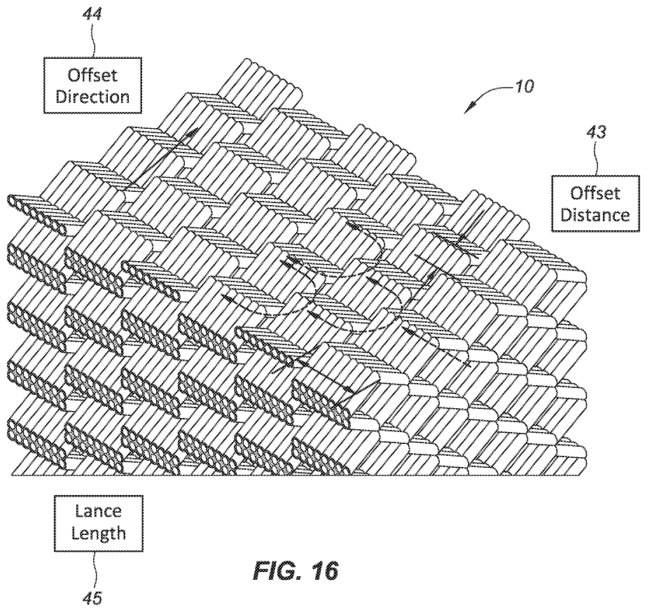

In the figures up to this point, the flow path of fluid B has been shown as a straight (or “plain”) path (See FIG. 4). However, in other embodiments, the fluid B flow path could take other forms, including a wavy path or a “lanced and offset”-style path. FIGS. 15 and 16 illustrate an isometric view of one embodiment of a matrix 10 with a fluid B flow path that is not straight. The fluid B flow path could add more turbulence to the fluid B flow, increasing heat transfer coefficient but also pressure loss. As shown in FIG. 15, when the fluid B channel is a wavy path, where each lattice is translated slightly to form a zig-zag fluid B flow path, there are two additional variables for the designer to adjust—path wavelength 40 and path wave angle 42. For a “lanced and offset” path, where lattices are grouped into “lances” and each lance is translated or “offset” to force the fluid B flow path to split at each new lance, the designer can adjust lance length 45 (i.e. number of lattices patterned in the fluid B flow direction), offset direction 44 and distance 43; any of these three dimensions could be varied for each lance.

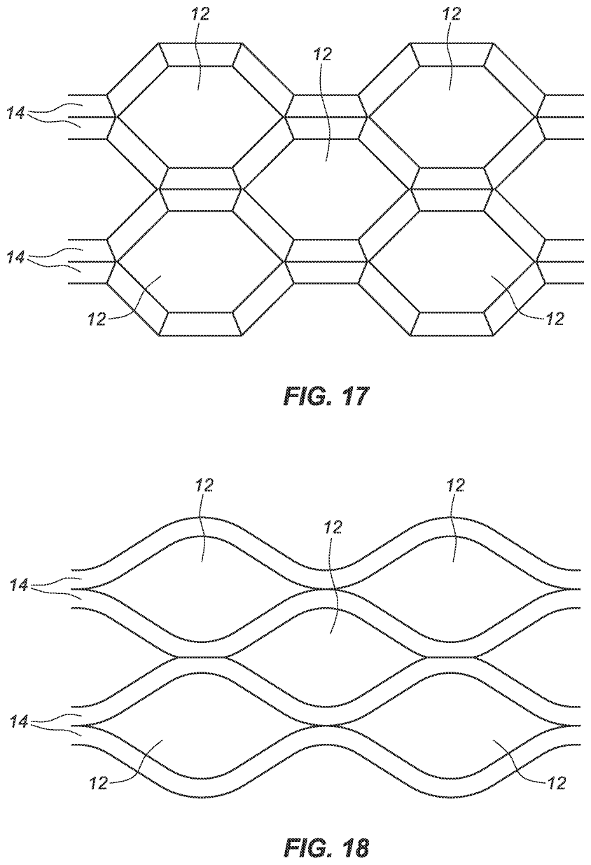

In some embodiments, the flow path of the fluid A channel 14 does not have to be zig-zag shaped, which form four-sided fluid B paths, typically diamond shapes. Many different matrix geometries may be implemented. In preferred embodiments, the fluid A paths are always some type of repeating wave. However, in other embodiments, other unique non-repeating waves could be used. FIG. 17 illustrates a trapezoidal Fluid A path. FIG. 18 illustrates a sinusoidal Fluid A path. It should be noted that changing the flow path of fluid A will also change the cross-section of fluid B channels. In other embodiments, other fluid A paths could include any type of swept path, curve or trajectory.

While in all cases so far the fluid A channels have been illustrated with a circular cross section, they could be any shape which fulfils the performance and packaging requirements including triangle, square, rectangular, hexagon, octagon, pentagon or any other shape. The fluid A channels could also have a cross-section that is a continuous curve all the way around with any number of variations.

Adjacent fluid A channels may overlap part or all of their wall thickness to create a structurally robust single-piece matrix

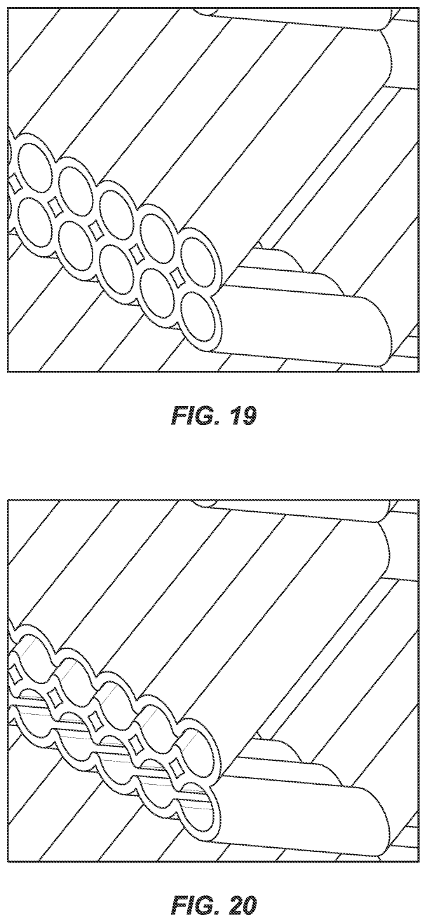

As discussed above, the flow paths of the fluid A channels 14 are arranged on a plane and connect, forming the perimeters of the fluid B channels 12. This resulting lattice is then repeated in the direction normal to the plane with each overlapping the next. The amount that each lattice of fluid A channels is offset from the next determines the amount of overlap. In most embodiments, the overlap is up to one wall thickness or less. In such embodiments, fluid cannot flow between adjacent channels. FIG. 19 illustrates an isometric view showing the spacing between the fluid A channels in an embodiment where fluid cannot flow between the A channels.

In other embodiments, the fluid A channels are offset less than a full diameter of the fluid A channel and overlap enough that fluid can flow between adjacent fluid A channels. FIG. 20 illustrates an isometric view showing the spacing between the fluid A channels in an embodiment where fluid can flow between the A channels.

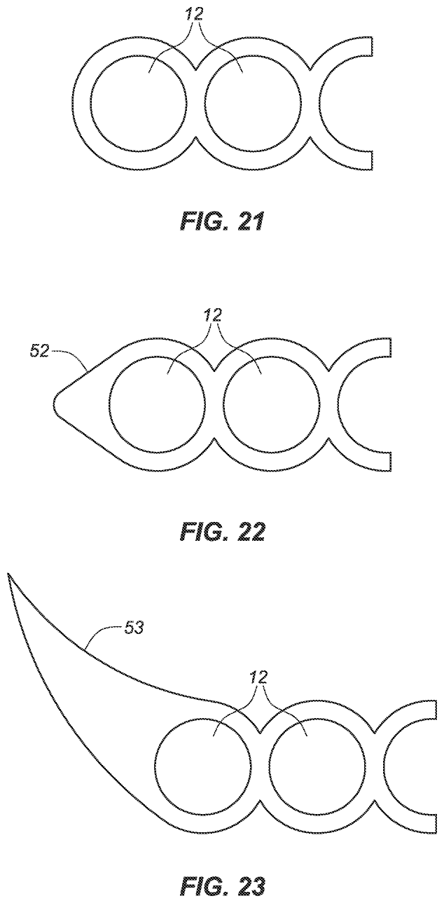

“Micro-features” can be incorporated into any of the heat exchanger designs in order to improve performance. A few examples of potential micro-features are: Fins that are added to fluid B channels in order to increase surface area; Surface roughness of the channels can be tuned in certain locations in order to increase turbulence; The inlets to the fluid B channels can be profiled in order to reduce entrance pressure loss. As shown in FIGS. 21-23, the inlet can be profiled from not at all as shown in FIG. 21, to slightly profiled 52 for a normal flow as in FIG. 22, to more significantly profiled 53 for an inclined flow as shown in FIG. 23. For a matrix with lanced and offset fluid B path, the entrance to each lanced section can also be profiled.

While the heat exchanger concept has been pictured thus far as having a cuboid shape the heat exchanger matrix 10 is not limited to cuboid forms. The matrix 10 can be curved in one or more directions to match the curvature of the engine core, or can be designed to conform to an unconventional space envelope. To this end, the third direction may be an arc, swept arc, circle or any other shape. In general, the third direction has been described as orthogonal to the first and second directions. This is generally true even for unconventional shapes if the direction is considered with respect to the to the plane of the cross-section of B channels.

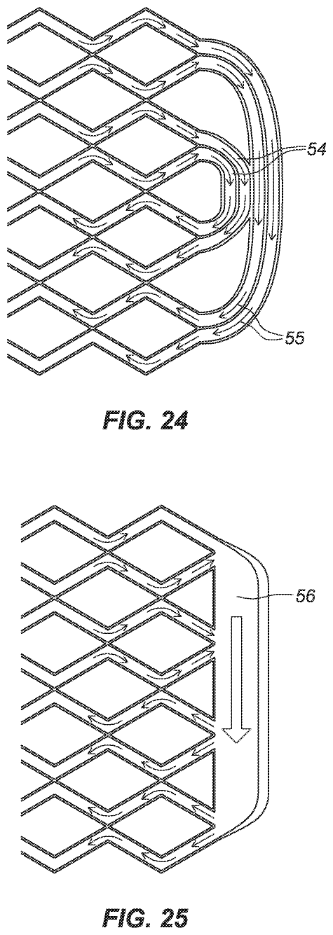

In different embodiments, the heat exchanger 10 may have either one pass or multiple passes on the fluid A side. A multi-pass heat exchanger could be configured as cross flow, parallel cross flow or counter cross flow. The turns of a multi-pass heat exchanger could manifest as either internal or external turns. Internal turns could be formed by directly linking the first-pass outlet of a fluid A channel to its corresponding second-pass inlet. FIG. 24 illustrates a cross-sectional view of a heat exchanger matrix with internal turns 54. External turns could be formed by adding a “return header”. FIG. 25 illustrates a cross-sectional view of a heat exchanger matrix with an external turn 55.

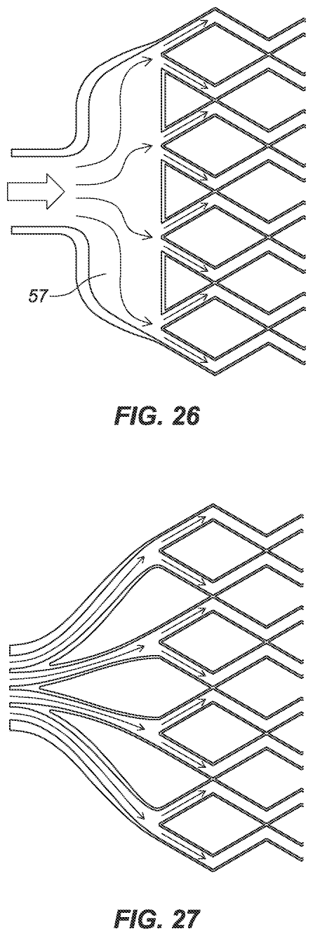

In some embodiments, the inlet and outlet headers could be integrated with the matrix and built as a single piece using additive manufacture. FIG. 26 illustrates a cross-sectional view of a traditional header 57, with the fluid A flow entering into a single cavity and into the matrix through a tube-plate style interface. FIG. 27 illustrates a cross-section view of a different embodiment, made possible by the design freedom of additive manufacture, in which fluid could be routed from the inlet port into each individual fluid A channel row. This could have the added benefit of being thermally active, as fluid B could be allowed to pass between the individual routings and cool fluid A as it enters the matrix. Alternately, headers could be made separately (either via additive manufacture or traditional manufacturing methods) and joined to the matrix in a separate step.

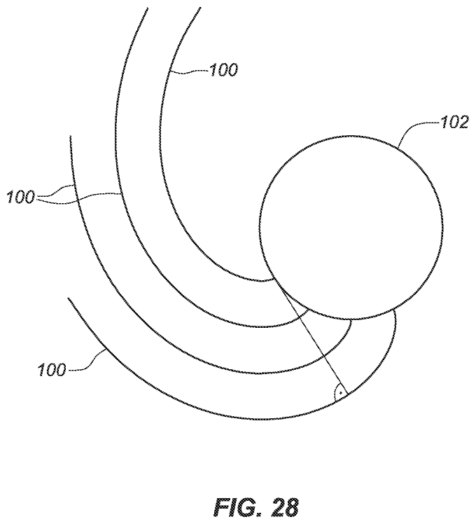

The heat exchangers disclosed and taught herein can take on many different overall shapes and sizes. There are many mathematical forms of a spiral which can be used but after investigating a number of these, the form known as an involute demonstrated many interesting properties. FIG. 28 illustrates a plurality of involutes 100. An involute 100 is the path described by the end of a piece of string as it is unwound from around a cylinder or circle 102. It can be seen that a line drawn tangent to the central circle intercepts normally to each spiral it intercepts, and that the distance between spirals along that line is constant.

When a section of a pattern of involutes is expressed with a symmetrically counter-rotating pattern, a lattice-like pattern is derived, as shown in Error! Reference source not found. This pattern has some interesting properties which may be advantageous for the creation of curved heat exchangers. The pattern can be adjusted by the following degrees of freedom: 1) The diameter of the based circle 102 compared to the inner diameter 103 and outer diameter 104 of the core section (as seen in Error! Reference source not found.); 2) The angular spacing between arms of the spiral.

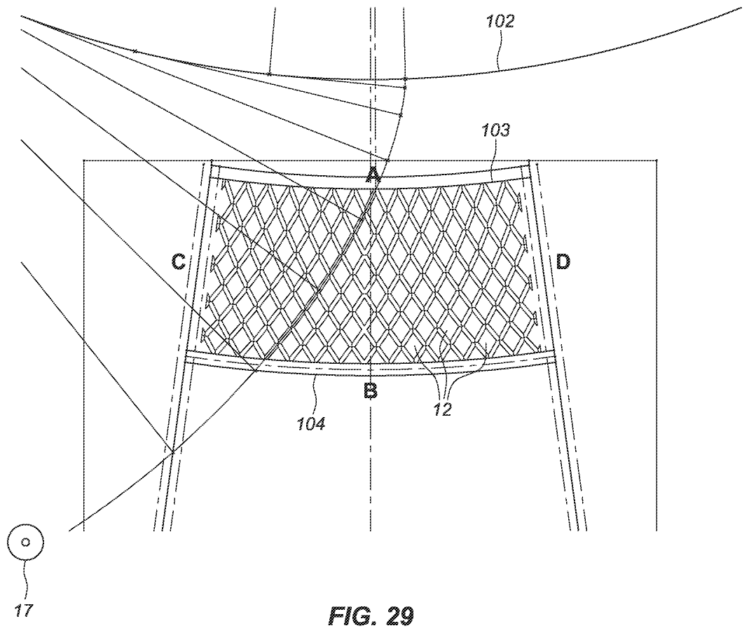

Generally speaking, the values of the two degrees of freedom above can vary. One of the primary drivers for the pattern is the build direction. Looking at FIG. 29, if the build direction is from face A or B then making sure that the channels do not overhang by more than 45° sets the minimum “base diameter” 102. As shown, if the base diameter 102 got any smaller the overhang would become unacceptable. If building from face C or D the base diameter would have a maximum size limit. If the build direction is in/out of the page than any base diameter is acceptable.

As taught herein, the involute lattice-like pattern can be copied in the axial direction or third direction 17, into and out of the page, to generate a three-dimensional heat exchanger matrix. One fluid flows through the hollow channels that form the lattice, A channels, while the second fluid flows axially through the resulting “diamond shaped” negative spaces formed by the lattice-like pattern, B channels 12.

The use of the involutes has interesting and useful properties. For example, the hydraulic diameter of each diamond shaped cell is the same, meaning that the coefficient of friction through any channel formed by multiple successive layers of the lattice would be nearly identical, particularly for high speed flows characteristic of the air side where frictional losses are characterized by hydraulic diameter and have almost no dependence on channel shape. Flow into the lattice would be largely homogenous as the nearly constant friction factor would promote equal mass flow across the height and span of the heat exchanger face. This will simplify the design of the associated duct-work in a heat exchanger mini-system.

FIG. 29 is an axial view down the fluid B channels showing the A channel lattice of a matrix with an involute construction. In the A channels of the lattice-like pattern, a fluid could travel either radially or tangentially between faces A & B and C & D respectively in Error! Reference source not found. This is assuming the channels are joined at each node and the fluid therein can meander along the channels in a zig-zag path. The existing state of the art in tube and plate form can only accommodate flows which move radially from the inside to the outside and must occupy the fully 360° circle, or else have offset inlets and outlets for those cores which are not fully 360°.

The simplest expression of the matrix formed from layers of the lattice-like pattern is where the diamond shaped cells of successive layers are aligned, as shown in Error! Reference source not found. The individual members of the lattice are shown as having a solid circular profile for ease of modelling; in a functional heat exchanger these would be hollow tubes which might have other profiles (e.g. elliptical or rectangular.

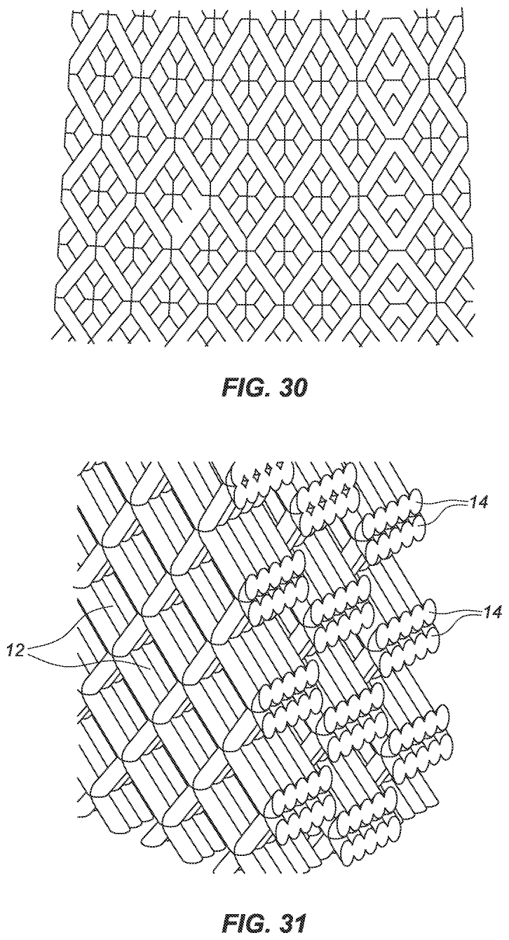

As already discussed, the A channels can be lanced and offset. FIG. 30 illustrates a view looking down the B channels of a lanced and offset heat exchanger matrix using involutes. FIG. 31 illustrates an isometric view of the lanced and offset heat exchanger matrix of FIG. 30.

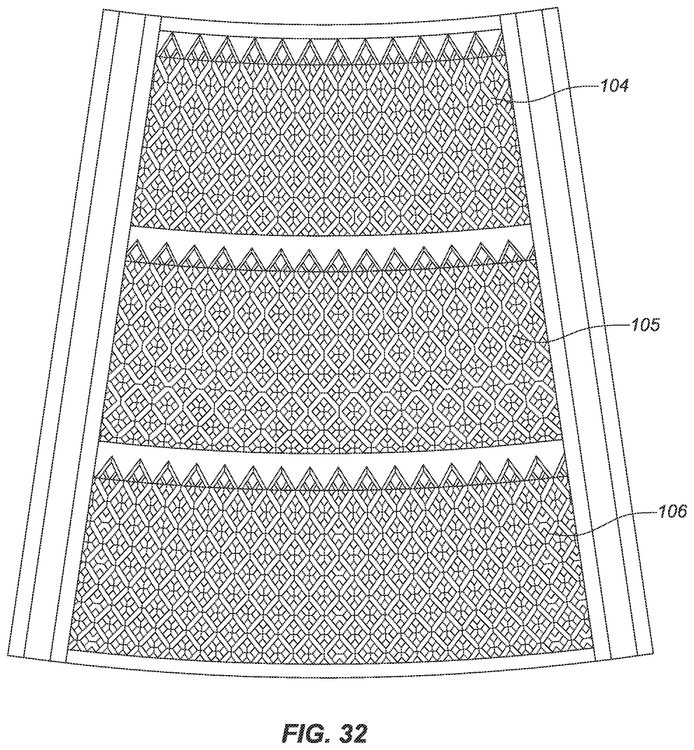

Creating heat exchanger cores using additive manufacturing is attractive because it permits a monolithic structure instead of an assembly of discrete components. There are a number of inherent restrictions/limitations to buildable geometries involved in additive manufacture though, not limited to the narrow range of build angles which can be utilized before the overhang becomes too great to self-support. The concepts shown in this document are with a build direction which is from the bottom to the top of FIG. 29 and FIG. 32 as shown on the page, where the face with the greatest radius would be at the bottom of the build. Other build directions may be used, but each will have challenges and limitations

With the build direction indicated it may be necessary to separate the heat exchanger into several sections, each with a slightly different involute pattern to maintain the constant hydraulic diameter property. FIG. 32 illustrates a heat exchanger core with three separate involute heat exchanger matrices 104, 105 and 106 in which the three zones 104, 105 and 106 have different lattice spacing angles and base circle diameters. One reason to separate the heat exchanger into separate sections is to reduce the change of angle of each branch from start to finish. Splitting into zones reduces this change of angle but; however, no part of the build should exceed the permissible overhang angle. Accordingly, in preferred embodiments, each section has the “base diameter” tuned to prevent overhangs on that section. With the base diameter constraint fixed, the angular spacing between the branches may be adjusted until each B channel has approximately the same hydraulic diameter.

As discussed, creating the matrix in three zones 104, 105 and 106 prevents from exceeding the build angle limit over the whole block. Where the lattice is changed from one pattern to another a transition between each pattern may need to be created depending on the build direction. The simplest transition are the rows with triangular edges as shown in FIG. 32. The downside to these triangular transitions is that they consume available heat exchange and flow area from the core block. Depending on the requirements of the heat exchanger, more complicated blends from one involute pattern to another may be desirable.

Splitting the core block into a greater number of sections also reduces the most extreme angle that the oil has to flow around as the flow direction is nominally tangential from one end of the core block to the other. The more sections the core is split into the greater the potential loss of heat exchanger and flow area so the overall optimum would need to be analyzed for each application.

A further application of splitting the cooler core into a number of sections is to embody multi-pass heat exchangers where one or more of the fluids will make greater than one passage across the core. In the example given in FIG. 32, with appropriate headers, the fluid passing through the involute lattice could make three passes entering at the top left and finally exiting at the bottom right

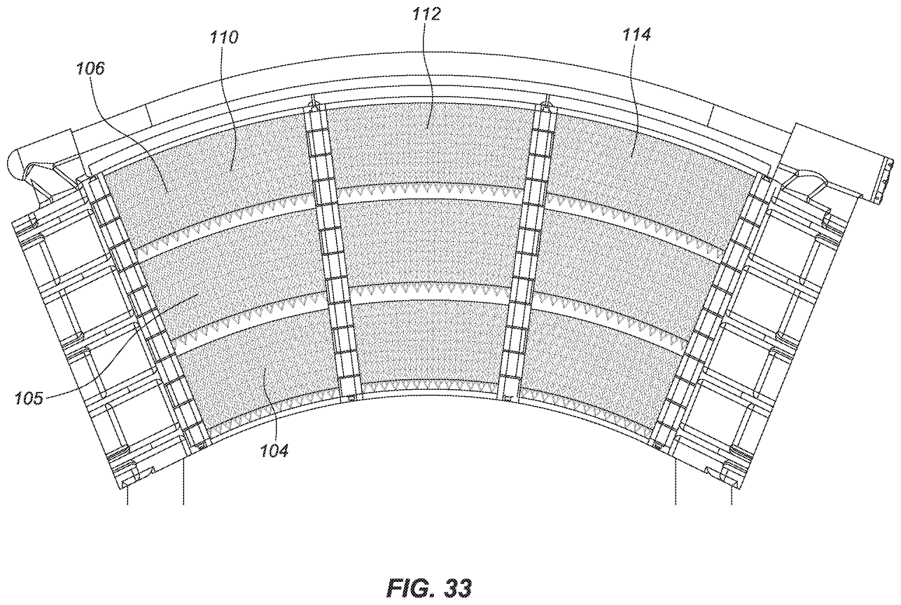

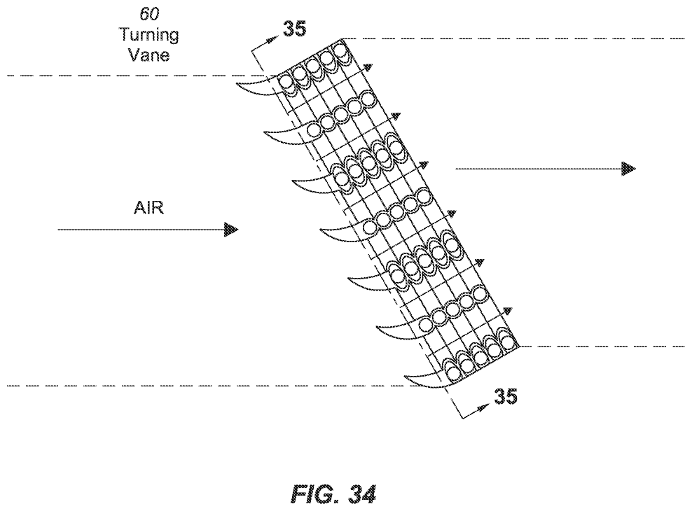

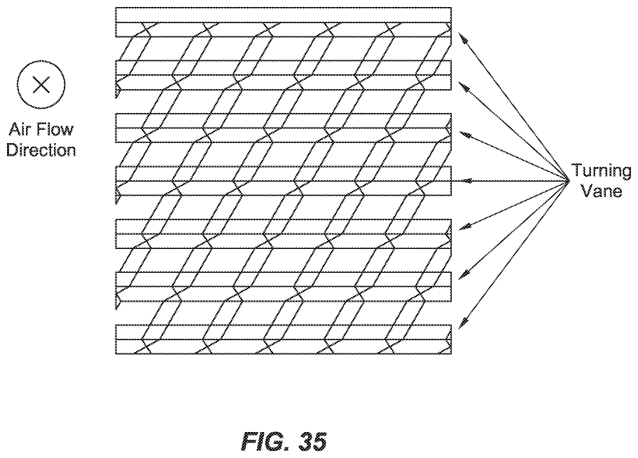

The size limitations imposed by the build chambers of additive manufacture machines may also necessitate splitting a heat exchanger up into a number of segments 110, 112, and 114. These segments 110, 112, and 114 could be joined to other accessories such as headers, bypass channels and aerodynamic aids to make complete cooler arrays. FIG. 33 illustrates a heat exchanger matrix using involutes with three segments 110, 112, and 114 wherein each segment has three sections 104, 105 and 106.

The involute lattice cooler blocks could also be combined or form a hybrid matrix with cuboid cooler blocks like those described in the first portion of this patent to form more complicated shapes combining curved and straight sections. The blocks could also be combined to accommodate heat exchange between greater numbers of fluids, for example where main gearbox and generator lubricating oil are cooled in a common air duct.

The heat exchanger may be manufactured using any material which is suitable for its application (e.g. environmental temperature, fluid pressures). This may include metals such as aluminium, titanium, steel, or nickel-based superalloys. It could also be made from a non-metallic material, such as plastic, ceramic, carbon, or resin.

In some embodiments, the heat exchanger can be integrated within a Ducted Air Oil Mini System, where the ducting within the mini system connects the heat exchanger to the bypass duct air flow. In this configuration the air flow is directed through the heat exchanger prior to being returned to the bypass duct. The air entering the heat exchanger is used as a heat sink for the hotter fluid being passed through the fluid channels within the heat exchanger. In order to enhance the ducted system's performance, variable channel geometries can be used within the heat exchanger to take advantage of non-uniform velocity profiles at the heat exchanger inlet. Further improvements to the heat exchanger performance can also be made with a variable cold flow length to further maximise performance with non-uniform velocity profiles.

The heat exchanger 10 can also be integrated into an Inclined Ducted Air Oil Mini System, in which the air front face of the heat exchanger matrix is not normal to the inlet air flow direction. Such a system is described and detailed in U.S. patent application Ser. No. 16/054,997, which is hereby incorporated by reference in its entirety. FIG. 28 illustrates a cross-sectional view of an angled cross-flow heat exchanger 10 with turning vanes 60 to guide airflow into the inclined heat exchanger. Turning vanes 60 can either be manufactured as part of the matrix or fixed to the core or ducting as separate components.

To enable the attachment of turning vanes 60, the matrix can be rotated such that fluid A channels 14 form a series of continuous horizontal surfaces to which horizontal turning vanes can be aligned (see FIG. 28).

FIG. 29 illustrates a sectional view along section A-A of FIG. 28 showing a lattice matrix which is rotated to provide a series of continuous horizontal surface for turning vane alignment. Here, turning vanes are shown as transparent.

What is claimed is:

1. A heat exchanger comprising:
a plurality of A channels in a heat exchanger matrix running in a first direction wherein each A channel in the plurality of A channels has an exterior with an exterior shape and an interior with an interior shape and wherein each A channel in the plurality of A channels is formed along its length as a waveform with an identical wavelength, channel width, wave angle, and wall thickness;
a first portion of A channels in the plurality of A channels offset in a second direction that is orthogonal to the first direction wherein adjacent A channels in the first portion of A channels are 180 degrees out of phase and wherein peaks and troughs of the adjacent A channels form nodes;
a plurality of B channels wherein a cross-section of each B channel in the plurality of B channels is formed between two nodes by negative space inside the exterior walls of the adjacent A channels;
and wherein a second portion of A channels in the plurality of A channels are arranged in a third direction orthogonal to the first direction and orthogonal to the second direction wherein each A channel in the first portion of A channels has a plurality of A channels in the second portion of A channels offset by an offset distance in the third direction to form continuous interior walls of the plurality of B channels in the third direction from the exterior walls of the plurality of A channels.

2. The heat exchanger of claim 1, wherein the exterior shape and interior shape are circles and the channel width is a diameter.

3. The heat exchanger of claim 2, wherein the cross-section of each B channel is four sided.

4. The heat exchanger of claim 3, wherein the cross-sectional perimeter of each B channel is a diamond.

5. The heat exchanger of claim 1, wherein the nodes are unlinked.

6. The heat exchanger of claim 5, wherein the adjacent A channels are offset in the second direction by an amplitude of the waveform.

7. The heat exchanger of claim 1, wherein the nodes are linked.

8. The heat exchanger of claim 7, wherein a diameter at a junction of the nodes is twice an interior diameter of an A channel in the plurality of A channels.

9. The heat exchanger of claim 1, wherein interior corners of each fluid B channel in the plurality of fluid B channels is rounded.

10. The heat exchanger of claim 1, wherein a flow path of each B channel in the plurality of B channels is not a straight line.

11. The heat exchanger of claim 1, wherein the second portion of A channels are lanced and offset.

12. The heat exchanger of claim 1, wherein offset distance is between one channel width and one channel width minus two times the wall thickness.

13. The heat exchanger of claim 1, wherein offset distance is less than one channel width minus two times the wall thickness such that the interiors of A channels adjacent in the third direction are connected along a length.

14. A heat exchanger comprising:
a plurality of A channels in a heat exchanger matrix running in a first direction wherein each A channel in the plurality of A channels has an exterior with an exterior shape and an interior with an interior shape and wherein each A channel in the plurality of A channels is formed along its length as a waveform with an identical wavelength, channel width, wave angle, and wall thickness;
a first portion of A channels in the plurality of A channels mirrored in a second direction that is orthogonal to the first direction about a mirror plane to form adjacent A channels in the plurality of A channels, wherein the mirror plane is defined by either a plurality of peaks or a plurality of troughs of the first portion of A channels and wherein peaks and troughs of adjacent A channels form nodes
a plurality of B channels wherein a cross-section of each B channel in the plurality of B channels is formed between two nodes by negative space inside the exterior walls of the first portion of A channels and adjacent A channels;
and wherein a second portion of A channels in the plurality of A channels are arranged in a third direction orthogonal to the first direction and orthogonal to the second direction wherein each A channel in the first portion of A channels has a plurality of A channels in the second portion of A channels offset by an offset distance in the third direction to form continuous interior walls of the plurality of B channels in the third direction from the exterior walls of the plurality of A channels.

15. The heat exchanger of claim 14, wherein the exterior shape and interior shape are circles and the channel width is a diameter.

16. The heat exchanger of claim 15, wherein the cross-section of each B channel is four sided.

17. The heat exchanger of claim 16, wherein the cross-sectional perimeter of each B channel is a diamond.

18. The heat exchanger of claim 14, wherein interior corners of each fluid B channel in the plurality of fluid B channels is rounded.

19. The heat exchanger of claim 14, wherein a flow path of each B channel in the plurality of B channels is not a straight line.

20. The heat exchanger of claim 14, wherein the second portion of A channels are lanced and offset.

21. The heat exchanger of claim 14, wherein offset distance is between one channel width and one channel width minus two times the wall thickness.

22. The heat exchanger of claim 14, wherein offset distance is less than one channel width minus two times the wall thickness such the interiors of A channels adjacent in the third direction are connected along a length.
